(19) United States
(12) Patent Application Publication
(10) Pub. No.: US 2023/0209514 A1
(43) Pub. Date: Jun. 29, 2023

(54) REPETITIONS OF UPLINK TRANSMISSIONS FOR MULTI-TRP OPERATION

(71) Applicant: Samsung Electronics Co., Ltd., Suwon-si (KR)

(72) Inventors: Carmela Cozzo, San Diego, CA (US); Aristides Papasakellariou, Houston, TX (US); Dalin Zhu, Allen, TX (US)

(21) Appl. No.: 18/063,619

(22) Filed: Dec. 8, 2022

Related U.S. Application Data
(60) Provisional application No. 63/293,622, filed on Dec. 23, 2021.
(60) Provisional application No. 63/349,387, filed on Jun. 6, 2022.

(51) Int. Cl. H04W 72/0446

(52) U.S. Cl. CPC H04W 72/0446

(57) ABSTRACT

Apparatuses and methods for repetitions of uplink (UL) transmissions for multi-transmit receive point (TRP) operation. A method for operating a user equipment (UE) includes receiving information for synchronization signals and physical broadcast channel (SS/PBCH) blocks over a first set of symbols of a slot and parameters for transmission of a physical uplink shared channel (PUSCH). The SS/PBCH blocks are associated with physical cell identities (PCIs) that are different than a PCI of a serving cell of the UE. The method further includes identifying, according to the parameters, a second set of symbols in the slot for transmission of the PUSCH and determining an availability of the slot for the transmission of the PUSCH when the second set of symbols does not include any symbol from the first set of symbols.

### CROSS-REFERENCE TO RELATED APPLICATION AND CLAIM OF PRIORITY

This application claims priority under 35 U.S.C. § 119(e) to U.S. Provisional Patent Application No. 63/293,622 filed on Dec. 23, 2021, and U.S. Provisional Patent Application No. 63/349,387 filed on Jun. 6, 2022. The above-identified provisional patent applications are hereby incorporated by reference in their entirety.

### TECHNICAL FIELD

The present disclosure relates generally to wireless communication systems and, more specifically, to repetitions of uplink (UL) transmissions for multi-transmit receive point (TRP) operation.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for repetitions of UL transmissions for multi-TRP operation.

In one embodiment, a user equipment (UE) is provided. The UE includes a transceiver configured to receive information for synchronization signals and physical broadcast channel (SS/PBCH) blocks over a first set of symbols of a slot, and parameters for transmission of a physical uplink shared channel (PUSCH). The SS/PBCH blocks are associated with physical cell identities (PCIs) that are different than a PCI of a serving cell of the UE. The UE further includes a processor operably coupled to the transceiver. The processor is configured to identify, according to the parameters, a second set of symbols in the slot for transmission of the PUSCH and determine an availability of the slot for the transmission of the PUSCH when the second set of symbols does not include any symbol from the first set of symbols.

In another embodiment, a base station (BS) is provided. The BS includes a transceiver configured to transmit information for SS/PBCH blocks over a first set of symbols of a slot and parameters for reception of a PUSCH. The SS/PBCH blocks are associated with PCIs that are different than a PCI of a serving cell. The BS further includes a processor operably coupled to the transceiver. The processor is configured to identify, according to the parameters, a second set of symbols in the slot for reception of the PUSCH and determine an availability of the slot for the reception of the PUSCH when the second set of symbols does not include any symbol from the first set of symbols.

In yet another embodiment, a method for operating a user equipment (UE) is provided. The method includes receiving information for SS/PBCH blocks over a first set of symbols of a slot and parameters for transmission of a PUSCH. The SS/PBCH blocks are associated with PCIs that are different than a PCI of a serving cell of the UE. The method further includes identifying, according to the parameters, a second set of symbols in the slot for transmission of the PUSCH and determining an availability of the slot for the transmission of the PUSCH when the second set of symbols does not include any symbol from the first set of symbols.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to embodiments of the present disclosure;

FIG. 6 illustrates an example method for a UE to receive information for SS/PBCH blocks that are associated with PCIs that are different than a PCI of a serving cell according to embodiments of the disclosure;

FIG. 7 illustrates an example method for a UE to determine an availability of symbols for PUSCH transmission when the UE is configured to receive SS/PBCH blocks associated with PCIs that are different than a PCI of a serving cell from according to embodiments the disclosure;

FIG. 8 illustrates an example method for a UE to transmit a PUSCH with repetitions when the UE is configured with AvailableSlotCounting enabled and to receive SS/PBCH blocks associated with PCIs that are different than a PCI of a serving cell according to embodiments the disclosure;

FIG. 9 illustrates an example method for determining a prioritization for simultaneous transmissions according to embodiments of the disclosure;

FIG. 10 illustrates an example method for determining a prioritization for simultaneous transmissions when one transmission is configured with DM-RS bundling according to embodiments of the disclosure;

FIG. 11 illustrates an example method for determining a prioritization for simultaneous transmissions when first and second transmissions are with repetitions or TB processing over multiple slots and with DM-RS bundling according to embodiments of the disclosure;

FIG. 12 illustrates an example method for determining a prioritization for simultaneous transmissions over multiple cells according to embodiments of the disclosure; and

FIG. 13 illustrates an example method for determining a prioritization for simultaneous transmissions over multiple uplink carriers according to embodiments of the disclosure;

### DETAILED DESCRIPTION

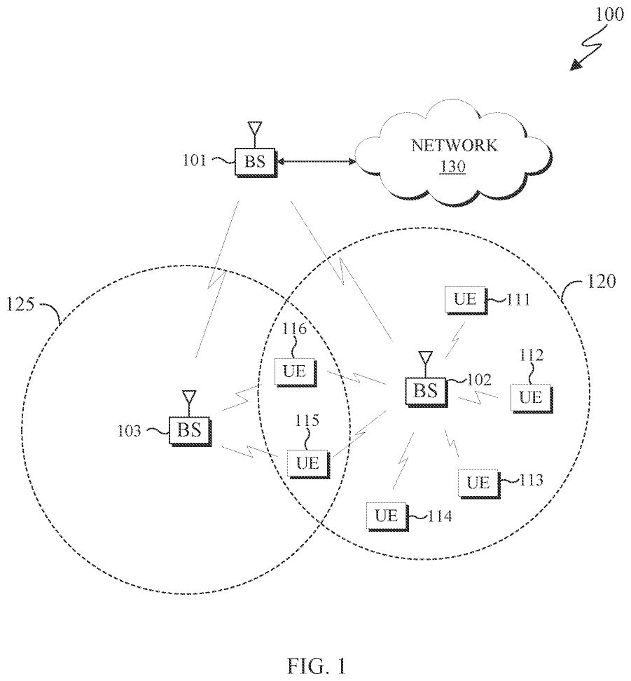

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents are hereby incorporated by reference into the present disclosure as if fully set forth herein: 3GPP TS 38.211 v17.3.0, “NR; Physical channels and modulation” (“REF1”); 3GPP TS 38.212 v17.3.0, “NR; Multiplexing and channel coding” (“REF2”); 3GPP TS 38.213 v17.3.0, “NR; Physical layer procedures for control” (“REF3”); 3GPP TS 38.214 v17.3.0, “NR; Physical layer procedures for data” (“REF4”); 3GPP TS 38.321 v17.2.0, “NR; Medium Access Control (MAC) protocol specification” (“REF5”); and 3GPP TS 38.331 v17.2.0, “NR; Radio Resource Control (RRC) protocol specification” (“REF6”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for triggering methods for repetitions of uplink transmissions for multi-TRP operation. In certain embodiments, one or more of the BSs 101-103 include circuitry, programing, or a combination thereof for triggering methods for repetitions of uplink transmissions for multi-TRP operation.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

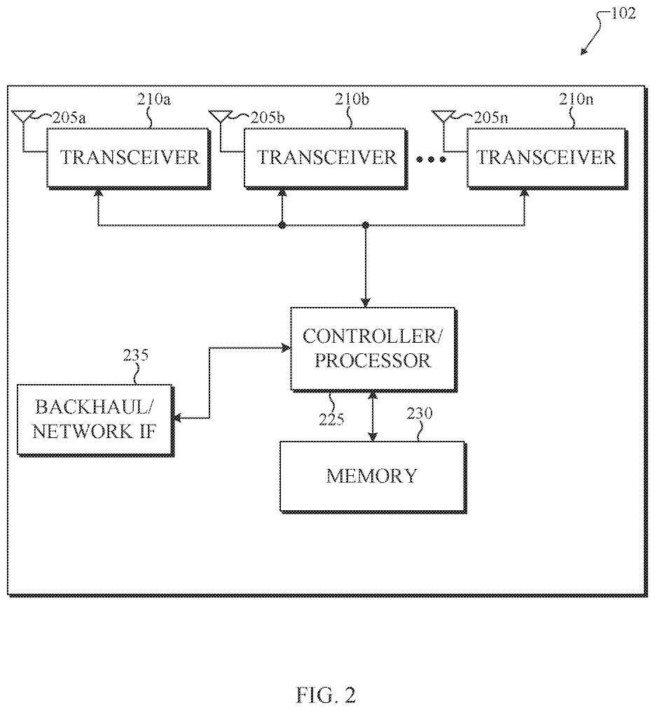

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for uplink transmission in full duplex systems. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

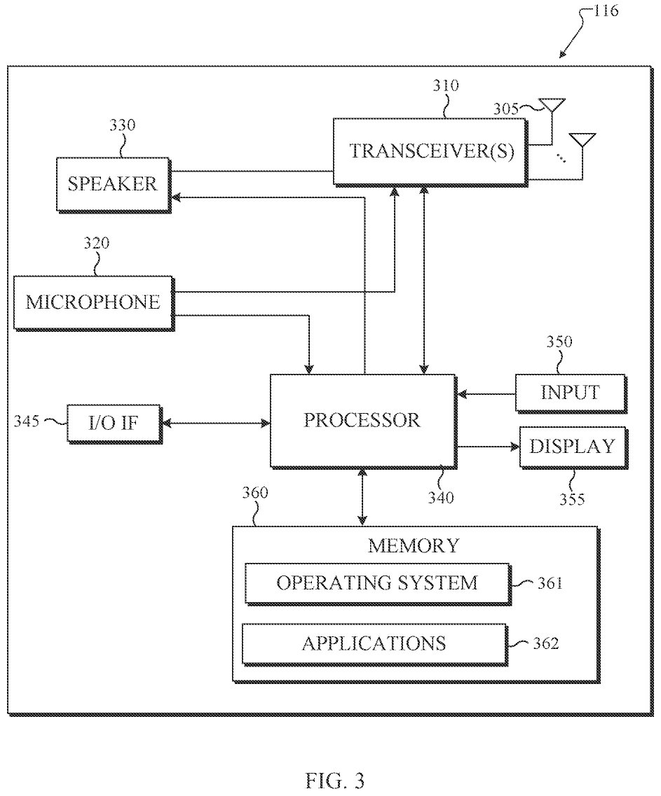

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

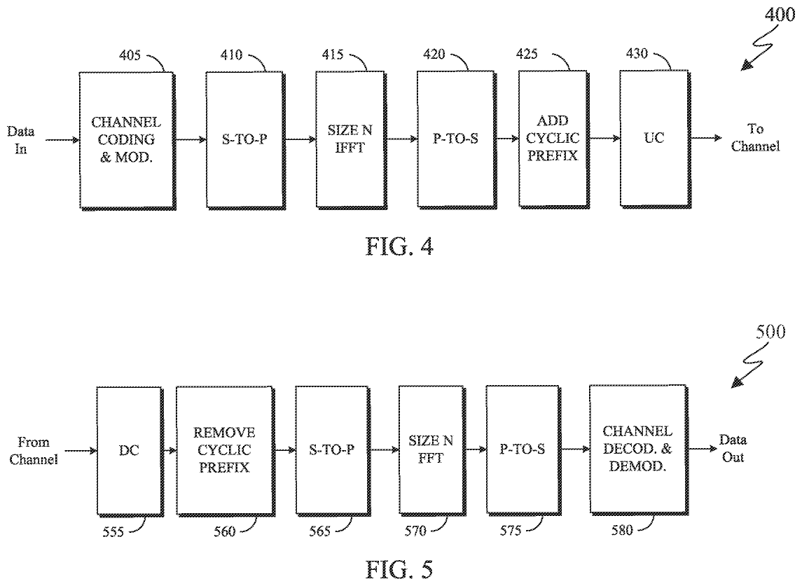

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support triggering methods for repetitions of uplink transmissions for multi-TRP operation as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In order to improve a reception reliability, a UE can transmit a physical uplink data channel (PUSCH) over a number of time units corresponding to a number of repetitions. A PUSCH can be transmitted with Type A or Type B repetitions. For PUSCH repetition Type A, a UE determines a starting symbol S relative to the start of a slot and a number of consecutive symbols L for a repetition of a PUSCH transmission from the start and length indicator value, SLIV, of an indexed row of a time domain resource allocation (TDRA) table. A UE determines a number of repetitions K from the row of the TDRA table or from a higher layer parameter, and repeats the PUSCH transmission across the K consecutive slots by applying a same symbol allocation in each slot. In the following, for brevity, an italicized parameter name refers to a higher layer parameter. The UE transmits a repetition of the PUSCH transmission in a slot only when L consecutive symbols in the slot, starting from symbol S, are not downlink (DL) symbols. For PUSCH repetition Type B, the starting symbol S relative to the start of the slot, and the number of consecutive symbols L counting from the symbol S allocated for the PUSCH, are provided by startSymbol and length of the indexed row of the resource allocation table, respectively. The number of nominal repetitions is given by numberofrepetitions.

When a UE is provided an UL-DL TDD configuration over a number of slots, is configured for PUSCH transmission with repetition Type A, and is scheduled by a DCI format to transmit the PUSCH over a number of slots n, the UE transmits a first PUSCH repetition over a first slot that is available for the PUSCH transmission, a second PUSCH repetitions over a next slot available for the PUSCH transmission, and so on. The UE transmits the PUSCH with repetitions until the n-th slot after the first slot. The total number of PUSCH repetitions can be less than the value n when any of the n consecutive slots is not available for the PUSCH transmission. A slot can be determined as unavailable for the PUSCH transmission when it does not include a number of consecutive UL symbols for a PUSCH transmission starting from a first symbol as indicated by the SLIV parameter of a time domain allocation table provided by the DCI format. A slot can be also determined as unavailable for the PUSCH transmission if at least one of the symbols indicated by the indexed row of the time domain resource allocation table in the slot overlaps with a symbol of an SS/PBCH block with index provided by ssb-PositionInBurst. For example, the determination of an unavailable slot can be based on an overlap of a symbol in the slot for a repetition with a symbol corresponding to reception of SS/PBCH blocks in the slot with candidate SS/PBCH block indexes indicated to a UE by ssb-PositionsInBurst in SIB1, or by ssb-PositionsInBurst in ServingCellConfigCommon. Determination of an available slot for PUSCH or PUCCH transmission based on symbols indicated by higher layers for transmission of SS/PBCH blocks by a gNB applies to a UE operating in unpaired spectrum or in paired spectrum or with SUL.

When a UE is configured for PUSCH transmission with repetition Type A that is dynamically scheduled or semi-statically configured over a number of slots n, the UE transmits a first PUSCH repetition over a first slot that is available for the PUSCH transmission, a second PUSCH repetitions over a next slot available for the PUSCH transmission, and so on until a counting of available slots is n wherein the number of transmitted PUSCH repetitions is also n, or until the counting of consecutive slots is n wherein the number of transmitted PUSCH repetitions can be less or equal to n. A gNB can configure whether the counting of repetitions is based on available slots or on consecutive physical slots. The terminology of available slot is used throughout this disclosure to indicate a slot that is available for UL transmission of a PUSCH or a PUCCH which is dynamically scheduled or semi-statically configured, wherein the actual transmission of the PUSCH or PUCCH may or may not occur.

When a UE is configured for Multiple Transmit/Receive Point (multi-TRP) operation, the UE can be scheduled by a serving cell from two or more TRPs in order to provide better PDSCH coverage, reliability and/or data rates. There are two different operation modes for multi-TRP: single-DCI and multi-DCI. For both modes, control of uplink and downlink operation can be done by physical layer and MAC layer, within the configuration provided by the RRC layer. In single-DCI mode, UE is scheduled by the same DCI for all TRPs and in multi-DCI mode, UE is scheduled by independent DCIs from each TRP.

Embodiments in this disclosure described for a UE that is configured with multi-TRP operation with a serving cell TRP and another TRP with a different PCI from the PCI of the serving cell equally apply to the case with a serving cell TRP and a number of non-serving cell TRPs with different PCIs from the PCI of the serving cell.

Embodiments in this disclosure described for PUSCH transmission of PUSCH type A repetitions equally apply to other uplink transmissions, wherein the uplink transmission is dynamically scheduled by a DCI format or by a RAR uplink grant, or semi-statically configured. For example, embodiments apply to PUSCH transmission of PUSCH type B repetitions and to PUCCH transmission of PUCCH repetitions.

Embodiments in this disclosure also apply to a UE that is configured with multi-TRP operation with a serving cell TRP and another TRP with a different PCI from the PCI of the serving cell for a PUSCH transmission of TB processing over multiple slots.

The present disclosure relates to aspects of repetitions of uplink transmissions for multi-TRP operation. The present disclosure relates to determining an availability of a slot for repetition of a PUSCH or PUCCH transmission based on overlapping with SS/PBCH block reception wherein the SS/PBCH blocks are transmitted independently from different cells.

A UE can receive SS/PBCH blocks in slots with candidate SS/PBCH block indexes indicated by ssb-PositionsInBurst in SIB1, or by ssb-PositionsInBurst in ServingCellConfigCommon. When the UE is configured for multi-TRP operation, the UE can receive SS/PBCH blocks from different cells wherein the SS/PBCH blocks are transmitted independently from different cells and are transmitted in slots with candidate SS/PBCH block indexes indicated by RRC parameters. For example, for a UE configured with multi-TRP operation with a serving cell TRP and a TRP with different PCI from the serving cell PCI, candidate SS/PBCH block indexes can be indicated by a single RRC parameter ssb-PositionsInBurst that includes the SS/PBCH block indexes from the serving cell TRP and the other TRP with different PCI, and the information can be in different fields or in a same field of the ssb-PositionsInBurst. It is also possible that candidate SS/PBCH block indexes are indicated by different RRC parameters, wherein a first RRC parameter ssb-PositionsInBurst indicates the candidate SS/PBCH block indexes for transmission by the serving cell TRP and a second RRC parameter ssb-PositionsInBurst in SSB-MTC-AdditionalPCI indicates the candidate SS/PBCH block indexes for transmission by the non-serving cell TRP with a different PCI from the serving cell PCI. When the UE is configured with a serving cell TRP and with a number of other TRPs with different PCIs, candidate SS/PBCH block indexes for transmission by the non-serving TRPs with different PCIs and associated with transmission configuration indication (TCI) states, can be indicated by different RRC parameters for each of the non-serving cell TRPs. For example, an RRC parameter SSB-MTC-AdditionalPCI for each non-serving cell TRP with a different PCI from the serving cell PCI can indicates the SS/PBCH block indexes for that TRP, or different fields of a same RRC parameter can indicate SS/PBCH block indexes for corresponding TRPs with different PCIs.

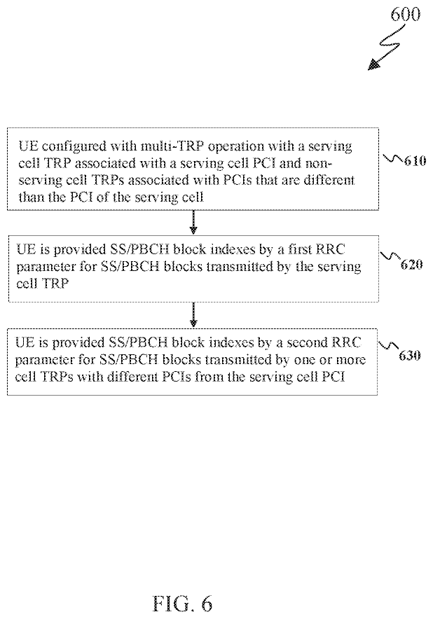

FIG. 6 illustrates an example method 600 for a UE to receive information for SS/PBCH blocks that are associated with PCIs that are different than a PCI of a serving cell according to embodiments of the disclosure. The embodiment of the example method 600 for a UE to receive information for SS/PBCH blocks that are associated with PCIs that are different than a PCI of a serving cell illustrated in FIG. 6 is for illustration only. FIG. 6 does not limit the scope of this disclosure to any particular implementation of the example method for a UE to receive information for SS/PBCH blocks that are associated with PCIs that are different than a PCI of a serving cell.

As illustrated in FIG. 6, at step 610, a UE (such as the UE 116) is configured with multi-TRP operation with a serving cell TRP associated with a serving cell PCI and non-serving cell TRPs associated with PCIs that are different than the PCI of the serving cell. At step 620, the UE is provided SS/PBCH block indexes by a first RRC parameter for SS/PBCH blocks transmitted by the serving cell TRP. At step 630, the UE is provided SS/PBCH block indexes by a second RRC parameter for SS/PBCH blocks transmitted by one or more cell TRPs with different PCIs from the serving cell PCI.

When a UE is configured for multi-TRP operation with a serving cell TRP and one or more TRPs with different PCIs, receives an information of candidate SS/PBCH block indexes for the serving cell TRP and for the one or more TRPs with different PCIs in higher layer parameters, and is configured to transmit PUSCH or PUCCH with N repetitions using a counting of available slots, wherein the PUSCH or PUCCH transmission is dynamically scheduled by a DCI format or semi-statically configured, the UE determines a number of slots for the PUSCH or PUCCH transmission based on the information of candidate SS/PBCH block indexes for the serving cell TRP and/or for the one or more TRPs with PCIs different from the PCI of the serving cell TRP. A UE can determine whether a slot is not counted in the number of N slots for PUSCH or PUCCH transmission of a PUSCH or PUCCH repetition if at least one of the symbols indicated by the indexed row of the used resource allocation table in the slot overlaps with a symbol of an SS/PBCH block with index provided by a higher layer parameter for the serving cell TRP and/or provided by higher layer parameters for each of the one or more TRPs with different PCIs, wherein symbols of SS/PBCH blocks of the serving cell TRP and symbols of SS/PBCH blocks of the non-serving TRP can be different symbols.

In one embodiment, a UE is configured for multi-TRP operation with a serving cell TRP and a non-serving cell TRP, wherein the non-serving cell TRP is a TRP with a PCI different from the PCI of the serving cell TRP, and receives an information of candidate SS/PBCH block indexes for the serving cell TRP by a first RRC parameter and of candidate SS/PBCH block indexes for the non-serving cell TRP by a second RRC parameter. When the UE is configured to transmit PUSCH with N repetitions, if at least one of the symbols indicated by the indexed row of the used resource allocation table in the slot overlaps with a symbol of an SS/PBCH block of the serving cell TRP or with a symbol of an SS/PBCH block of the non-serving cell TRP, the UE does not transmit the PUSCH repetition.

For unpaired spectrum, when AvailableSlotCounting is enabled, the UE determines the N slots for a PUSCH transmission of a PUSCH repetition type A scheduled by DCI format 0_1 or 0_2, based on tdd-UL-DL-ConfigurationCommon, tdd-UL-DL-ConfigurationDedicated if provided, ssb-PositionsInBurst that provides the SS/PBCH block indexes of the serving cell TRP and ssb-PositionsInBurst in SSB-MTC-AdditionalPCI that provides the SS/PBCH block of the non-serving cell TRP, and the TDRA information field value in the DCI format 0_1 or 0_2. A slot is not counted in the number of N slots for PUSCH transmission of a PUSCH repetition Type A scheduled by DCI format 0_1 or 0_2 if at least one of the symbols indicated by the indexed row of the used resource allocation table in the slot overlaps with a DL symbol indicated by tdd-UL-DL-ConfigurationCommon or tdd-UL-DL-ConfigurationDedicated if provided, or a symbol of an SS/PBCH block with index provided by ssb-PositionsInBurst in SIB1 or in ServingCellConfigCommon or by ssb-PositionsInBurst in SSB-MTC-AdditionalPCI. Otherwise, when AvailableSlotCounting is not enabled the UE determines N consecutive slots for a PUSCH transmission of a PUSCH repetition type A scheduled by DCI format 0_1 or 0_2, based on the TDRA information field value in the DCI format 0_1 or 0_2.

For paired spectrum, when AvailableSlotCounting is enabled, the UE determines the N slots for a PUSCH transmission of a PUSCH repetition type A scheduled by DCI format 0_1 or 0_2, based on ssb-PositionsInBurst that provides the SS/PBCH block indexes of the serving cell TRP and ssb-PositionsInBurst in SSB-MTC-AdditionalPCI that provides the SS/PBCH block of the non-serving cell TRP, and the TDRA information field value in the DCI format 0_1 or 0_2. A slot is not counted in the number of N slots for PUSCH transmission of a PUSCH repetition Type A scheduled by DCI format 0_1 or 0_2 if at least one of the symbols indicated by the indexed row of the used resource allocation table in the slot overlaps with a symbol of an SS/PBCH block with index provided by ssb-PositionsInBurst in SIB1 or in ServingCellConfigCommon or by ssb-PositionsInBurst in SSB-MTC-AdditionalPCI. Otherwise, when AvailableSlotCounting is not enabled the UE determines N consecutive slots for a PUSCH transmission of a PUSCH repetition type A scheduled by DCI format 0_1 or 0_2, based on the TDRA information field value in the DCI format 0_1 or 0_2.

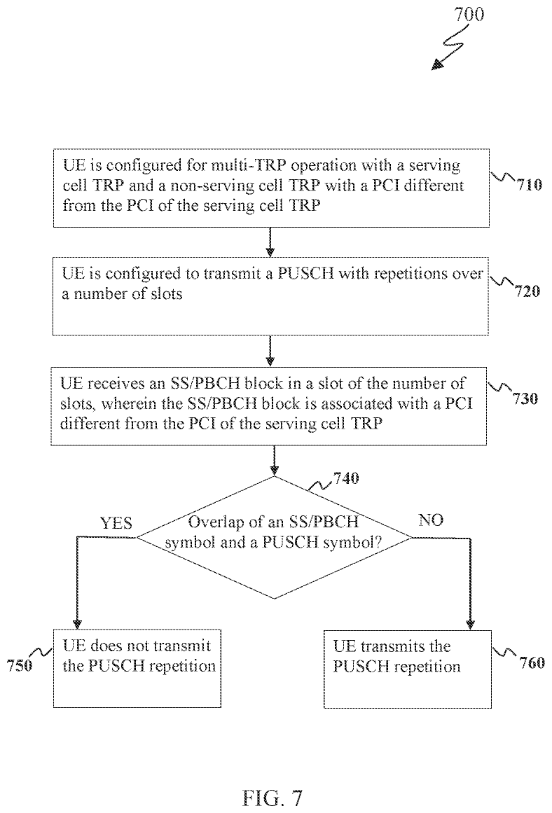

FIG. 7 illustrates an example method 700 for a UE to determine an availability of symbols for PUSCH transmission when the UE is configured to receive SS/PBCH blocks associated with PCIs that are different than a PCI of a serving cell from according to embodiments the disclosure. The embodiment of the example method 700 for a UE to determine an availability of symbols for PUSCH transmission when the UE is configured to receive SS/PBCH blocks associated with PCIs that are different than a PCI of a serving cell illustrated in FIG. 7 is for illustration only. FIG. 7 does not limit the scope of this disclosure to any particular implementation of the example method for a UE to determine an availability of symbols for PUSCH transmission when the UE is configured to receive SS/PBCH blocks associated with PCIs that are different than a PCI of a serving cell.

As illustrated in FIG. 7, at step 710, a UE (such as the UE 116) is configured for multi-TRP operation with a serving cell TRP and a non-serving cell TRP with a PCI different from the PCI of the serving cell TRP. At step 720, the UE is configured to transmit a PUSCH with repetitions over a number of slots. At step 730, the UE receives an SS/PBCH block in a slot of the number of slots, wherein the SS/PBCH block is associated with a PCI different from the PCI of the serving cell TRP. At step 740, when a symbol of the SS/PBCH block overlaps with a symbol of a PUSCH repetition, then at step 750, the UE does not transmit the PUSCH repetition. Otherwise, at step 760, the UE transmits the PUSCH repetition in the slot.

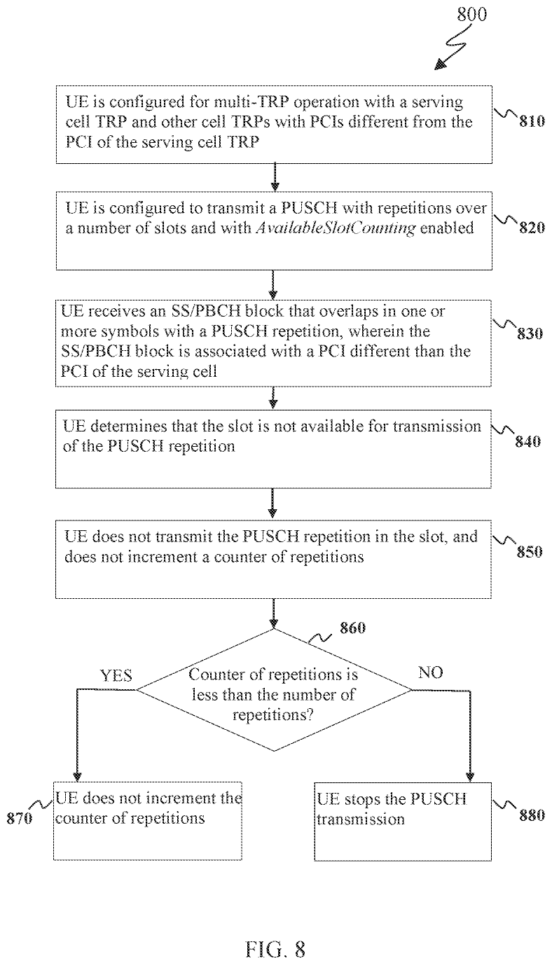

FIG. 8 illustrates an example method 800 for a UE to transmit a PUSCH with repetitions when the UE is configured with AvailableSlotCounting enabled and to receive SS/PBCH blocks associated with PCIs that are different than a PCI of a serving cell according to embodiments the disclosure. The embodiment of the example method 800 for a UE to transmit a PUSCH with repetitions when the UE is configured with AvailableSlotCounting enabled and to receive SS/PBCH blocks associated with PCIs that are different than a PCI of a serving cell illustrated in FIG. 8 is for illustration only. FIG. 8 does not limit the scope of this disclosure to any particular implementation of the example method for a UE to transmit a PUSCH with repetitions when the UE is configured with AvailableSlotCounting enabled and to receive SS/PBCH blocks associated with PCIs that are different than a PCI of a serving cell.

As illustrated in FIG. 8, at step 810, a UE (such as the UE 116) is configured for multi-TRP operation with a serving cell TRP and other cell TRPs with PCIs different from the PCI of the serving cell TRP. At step 820, the UE is configured to transmit a PUSCH with repetitions over a number of slots and with AvailableSlotCounting enabled. At step 830, the UE receives an SS/PBCH block that overlaps in one or more symbols with a PUSCH repetition, wherein the SS/PBCH block is associated with a PCI different than the PCI of the serving cell. At step 840, the UE determines that the slot is not available for transmission of the PUSCH repetition. At step 850, the UE does not transmit the PUSCH repetition in the slot, and does not increment a count of repetitions. At step 860, when a counter of repetitions is less than the number of repetitions, then at step 870, the UE postpones the PUSCH repetition to a subsequent available slot. Otherwise, at step 880, the UE stops the PUSCH transmission.

In another embodiment, a UE is configured for multi-TRP operation with a serving cell TRP and non-serving cell TRPs with PCIs different from the PCI of the serving cell TRP, and receives an information of candidate SS/PBCH block indices for the serving cell TRP by a first RRC parameter and of candidate SS/PBCH block indices for the non-serving cell TRPs by a second RRC parameter. When the UE is configured to transmit PUSCH with N repetitions, if one or more symbols of a PUSCH repetition overlap in time with one or more symbols of the SS/PBCH block associated with one of the PCIs different than the PCI of the serving cell and use frequency resources that do not include frequency resources of the SS/PBCH block, the UE transmits the PUSCH repetition.

In another embodiment, a UE is configured for multi-TRP operation with a serving cell TRP and a non-serving cell TRP, wherein the non-serving cell TRP is a TRP with a PCI different from the PCI of the serving cell TRP, and receives an information of candidate SS/PBCH block indexes for the serving cell TRP by a first RRC parameter and of candidate SS/PBCH block indexes for the non-serving cell TRP by a second RRC parameter. When the UE is configured to transmit PUSCH with N repetitions, if at least one of the symbols indicated by the indexed row of the used resource allocation table in the slot overlaps with a symbol of an SS/PBCH block of the serving cell TRP, the UE does not transmit the PUSCH repetition, and if at least one of the symbols indicated by the indexed row of the used resource allocation table in the slot overlaps with a symbol of an SS/PBCH block of the non-serving cell TRP, the UE transmits the PUSCH repetition.

For unpaired spectrum, when AvailableSlotCounting is enabled, the UE determines the N slots for a PUSCH transmission of a PUSCH repetition type A scheduled by DCI format 0_1 or 0_2, based on tdd-UL-DL-ConfigurationCommon, tdd-UL-DL-ConfigurationDedicated if provided, ssb-PositionsInBurst that provides the SS/PBCH block indexes of the serving cell TRP, and the TDRA information field value in the DCI format 0_1 or 0_2. A slot is not counted in the number of N slots for PUSCH transmission of a PUSCH repetition Type A scheduled by DCI format 0_1 or 0_2 if at least one of the symbols indicated by the indexed row of the used resource allocation table in the slot overlaps with a DL symbol indicated by tdd-UL-DL-ConfigurationCommon or tdd-UL-DL-ConfigurationDedicated if provided, or a symbol of an SS/PBCH block with index provided by ssb-PositionsInBurst. Otherwise, when AvailableSlotCounting is not enabled the UE determines N consecutive slots for a PUSCH transmission of a PUSCH repetition type A scheduled by DCI format 0_1 or 0_2, based on the TDRA information field value in the DCI format 0_1 or 0_2.

For paired spectrum, when AvailableSlotCounting is enabled, the UE determines the N slots for a PUSCH transmission of a PUSCH repetition type A scheduled by DCI format 0_1 or 0_2, based on ssb-PositionsInBurst that provides the SS/PBCH block indexes of the serving cell TRP, and the TDRA information field value in the DCI format 0_1 or 0_2. A slot is not counted in the number of N slots for PUSCH transmission of a PUSCH repetition Type A scheduled by DCI format 0_1 or 0_2 if at least one of the symbols indicated by the indexed row of the used resource allocation table in the slot overlaps with a symbol of an SS/PBCH block with index provided by ssb-PositionsInBurst. Otherwise, when AvailableSlotCounting is not enabled the UE determines N consecutive slots for a PUSCH transmission of a PUSCH repetition type A scheduled by DCI format 0_1 or 0_2, based on the TDRA information field value in the DCI format 0_1 or 0_2.

In yet another embodiment, a UE is configured for multi-TRP operation with a serving cell TRP and one or more non-serving cell TRP, wherein the non-serving cell TRPs are TRP with PCIs different from the PCI of the serving cell TRP, and receives an information of candidate SS/PBCH block indexes for the serving cell TRP by a parameter ssb-PositionsInBurst and of candidate SS/PBCH block indexes for the non-serving cell TRPs with PCIs different from the PCI of the serving cell TRP by a parameter ssb-PositionsInBurst in SSB-MTC-AdditionalPCI or by different parameters for each of the non-serving cell TRPs. When the UE is configured to transmit PUSCH with N repetitions, if at least one of the symbols indicated by the indexed row of the used resource allocation table in the slot overlaps with a symbol of an SS/PBCH block of the serving cell TRP or of an SS/PBCH block of a first non-serving cell TRP, wherein the first non-serving cell TRP is selected among the non-serving cell TRPs based on an RSRP measurement by the UE, the UE does not transmit the PUSCH repetition. If at least one of the symbols indicated by the indexed row of the used resource allocation table in the slot overlaps with a symbol of an SS/PBCH block of any of the non-serving cell TRPs other than the first non-serving TRP, the UE transmits the PUSCH repetition.

For unpaired spectrum, when AvailableSlotCounting is enabled, the UE determines the N slots for a PUSCH transmission of a PUSCH repetition type A scheduled by DCI format 0_1 or 0_2, based on tdd-UL-DL-ConfigurationCommon, tdd-UL-DL-ConfigurationDedicated if provided, ssb-PositionsInBurst that provides the SS/PBCH block indexes of the serving cell TRP and ssb-PositionsInBurst in SSB-MTC-AdditionalPCI that provides the SS/PBCH block of the non-serving cell TRP, and the TDRA information field value in the DCI format 0_1 or 0_2. A slot is not counted in the number of N slots for PUSCH transmission of a PUSCH repetition Type A scheduled by DCI format 0_1 or 0_2 if at least one of the symbols indicated by the indexed row of the used resource allocation table in the slot overlaps with a DL symbol indicated by tdd-UL-DL-ConfigurationCommon or tdd-UL-DL-ConfigurationDedicated if provided, or a symbol of an SS/PBCH block with index provided by ssb-PositionsInBurst for the serving cell TRP or by ssb-PositionsInBurst in SSB-MTC-AdditionalPCI for a first non-serving cell TRP. Otherwise, when AvailableSlotCounting is not enabled the UE determines N consecutive slots for a PUSCH transmission of a PUSCH repetition type A scheduled by DCI format 0_1 or 0_2, based on the TDRA information field value in the DCI format 0_1 or 0_2.

For paired spectrum, when AvailableSlotCounting is enabled, the UE determines the N slots for a PUSCH transmission of a PUSCH repetition type A scheduled by DCI format 0_1 or 0_2, based on ssb-PositionsInBurst that provides the SS/PBCH block indexes of the serving cell TRP and ssb-PositionsInBurst in SSB-MTC-AdditionalPCI that provides the SS/PBCH block of the non-serving cell TRP, and the TDRA information field value in the DCI format 0_1 or 0_2. A slot is not counted in the number of N slots for PUSCH transmission of a PUSCH repetition Type A scheduled by DCI format 0_1 or 0_2 if at least one of the symbols indicated by the indexed row of the used resource allocation table in the slot overlaps with a symbol of an SS/PBCH block with index provided by ssb-PositionsInBurst for the serving cell TRP or by ssb-PositionsInBurst in SSB-MTC-AdditionalPCI for a first non-serving cell TRP. Otherwise, when AvailableSlotCounting is not enabled the UE determines N consecutive slots for a PUSCH transmission of a PUSCH repetition type A scheduled by DCI format 0_1 or 0_2, based on the TDRA information field value in the DCI format 0_1 or 0_2.

In yet another embodiment, a UE determines whether to transmit a PUSCH in a slot where at least one of the symbols indicated by the indexed row of the used resource allocation table in the slot overlaps with a symbol of an SS/PBCH block with index provided by ssb-PositionsInBurst in SSB-MTC-AdditionalPCI for a non-serving cell TRP based on an RSRP measurement.

Further, a UE multiplexes a demodulation reference signal (DM-RS) in a physical uplink data channel (PUSCH) or in a physical uplink control channel (PUCCH) transmission in order to enable a receiver at a serving gNB to coherently demodulate modulated data information symbols or control information symbols in the PUSCH or in the PUCCH, respectively. The DM-RS is typically located in the earlier symbols of a PUSCH or PUCCH transmission to avoid a demodulation delay due to a processing time for obtaining a channel estimate to be used for the coherent demodulation of data/control symbols under the assumption of phase coherence among the DM-RS and the data/control symbols. For a PUSCH or PUCCH transmission over multiple slots, a way to improve an accuracy of channel estimates is to filter multiple DM-RS across more than one slots. Throughout this disclosure, the operation of DM-RS filtering over a number of slots is referred also as DM-RS bundling over a number of slots or over a time window or time domain window (TDW).

In order to enable filtering of multiple DM-RS, power consistency (same power) and phase continuity (same phase) of the filtered DM-RS needs to be maintained and that also applies to the power and phase of modulated data/control information symbols, for example in case of QAM modulation, in order to perform corresponding demodulation using the filtered DM-RS. Thus, when a UE is scheduled to transmit a PUSCH or a PUCCH with repetitions over a number of slots, the conditions that the UE should apply to maintain same power and phase continuity over a time period where the PUSCH or PUCCH repetitions are transmitted, include for the UE to not apply TPC commands and power changes to compensate for path loss estimates or for the UE to maintain a same precoding and spatial filter for the repetitions. For example, the PUSCH transmissions can be for PUSCH repetition type A scheduled by DCI format 0_1 or 0_2, or for PUSCH repetition Type A with a configured grant, or for PUSCH repetition type B or TB processing over multiple slots, or for PUCCH repetitions scheduled by a DCI format or configured by higher layer signaling such as RRC signaling.

A UE can transmit PUSCH or PUCCH repetitions in non-consecutive slots due to unavailability of time-frequency resources in some slots. For example, a slot may not include enough consecutive UL symbols for a PUSCH or PUCCH repetition, or may not be available for UL transmission by configuration or by means of a dynamic indication such as scheduling of a higher priority transmission, indication of a cancellation or indication of a slot as DL slot. Depending on the number of slots or symbols between two consecutive repetitions, referred to as transmission gap, the UE may or may not be able to maintain same power and phase continuity for transmission of repetitions within a time interval that includes repetitions before and after a transmission gap. When the UE is not able to maintain same power and phase continuity, a gNB can filter DM-RS symbols across multiple slots before the transmission gap to obtain a channel estimate to demodulate symbols of PUSCH or PUCCH receptions in the multiple slots before the transmission gap. After the transmission gap, DM-RS symbols across multiple slots may be filtered to obtain a channel estimate to demodulate the PUSCH or PUCCH receptions in the multiple slots after the transmission gap. It is also possible that, after the transmission gap, the UE is not required to maintain same power and phase consistency over the multiple slots.

When a UE is configured/scheduled to transmit a first PUSCH or PUCCH with repetitions over a number of slots and is configured with DM-RS bundling over a time window that includes some or all slots of the number of slots, the UE can receive an indication of scheduling of a second transmission in at least one of the slots included in the time window. The first transmission and the second transmission can be for a PUSCH with a configured grant, a PUSCH scheduled by a DCI format or corresponding to a Type 2 configured grant activated by a DCI format, a PUSCH repetition Type A, a PUSCH repetition Type B, or can be a PUSCH transmission of TB processing over multiple slots. It is also possible that either the first transmission or the second transmission, or both, is/are PUCCH transmission(s) with HARQ-ACK information associated a DCI format detected by the UE that may or may not schedule a PDSCH receptions. For example, the DCI format may schedule a SPS PDSCH release, or indicate SCell dormancy, or request a Type-3 HARQ-ACK codebook report without scheduling a PDSCH reception. The PUCCH transmission can also be for providing SR or a CSI report. The PUCCH transmission can be with repetitions, wherein the UE can be configured a number of slots, N_{PUCCH}^{repeat}, for repetitions of the PUCCH transmission, or can be configured a number of repetitions in a PUCCH resource indicated by a value of a PUCCH Resource Indicator (PRI) field in a DCI format triggering the PUCCH transmission. First and second transmissions can be scheduled on a same uplink carrier, or on a normal uplink carrier and a supplementary uplink carrier of a same cell, or for operation with carrier aggregation (CA), on a first cell and a second cell, respectively. When receiving scheduling information for the second transmission in a slot where the first transmission with repetitions and DM-RS bundling is ongoing, the UE may transmit one or both of the first or second transmission in that slot depending on priorities associated with the first and second transmission.

Therefore, there is a need to determine a prioritization for simultaneous transmissions when at least one of the transmissions is configured with DM-RS bundling.

There is another need to determine a prioritization for simultaneous transmissions when at least one of the transmissions is configured with DM-RS bundling for a UE configured for single cell operation with two uplink carriers or for operation with carrier aggregation.

When a UE is configured and/or scheduled to transmit a first PUSCH or PUCCH with repetitions over a first number of slots and a second PUSCH or PUCCH with repetitions over a second number of slots and is configured with DM-RS bundling operation, the operation of DM-RS bundling can be applied jointly over the first and second number of slots when requirements of power consistency and phase continuity can be maintained over the DM-RS and modulated data/control information symbols.

Therefore, there is yet another need to determine procedures to allow filtering of the DM-RS over slots where a UE has multiple transmissions.

The present disclosure relates to uplink transmissions when DM-RS bundling is enabled. The present disclosure also relates to a determination of a prioritization for transmission of a PUSCH and/or PUCCH configured with DM-RS bundling. The present disclosure further relates to a determination of a prioritization for transmission of a PUSCH and/or PUCCH configured with DM-RS bundling for a UE configured for single cell operation with two uplink carriers or for operation with carrier aggregation (CA). The present disclosure also relates to a determination of procedures for DM-RS bundling over slots with multiple scheduled transmissions.

Although some descriptions consider a PUSCH transmission with repetitions configured with DM-RS bundling over a time domain window of a number of slots or symbols and a second PUSCH transmission that is scheduled in at least one slot of the time domain window, same procedures apply when either the first transmission or the second transmission, or both, is/are PUCCH transmission(s).

Although some descriptions consider transmission of a channel with repetitions, same procedures apply for the transmission of a single TB over multiple slots, and for the transmission of a single TB over multiple slots with repetitions.

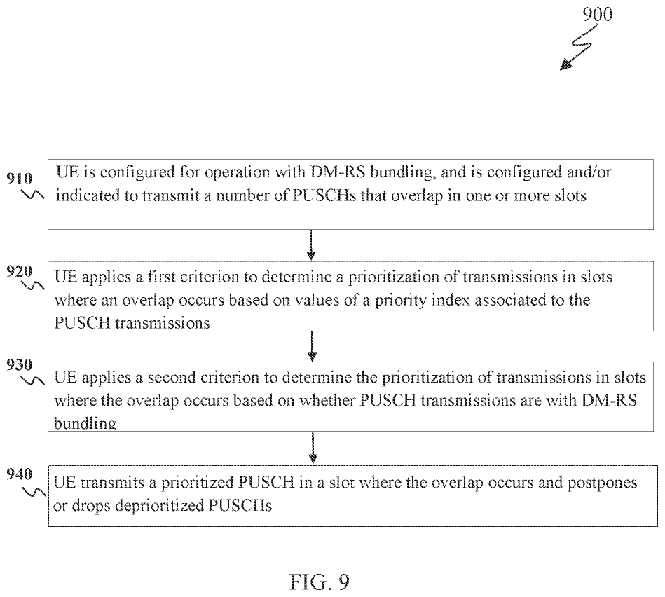

Embodiments of the present disclosure describe a determination of prioritizations of transmissions with DM-RS bundling for operation with single carrier. This is described in the following examples and embodiments, such as those of FIGS. 9-11.

When a UE is configured and/or indicated to transmit a first PUSCH with L repetitions or TB processing over multiple slots in slots n=1, . . . , L and is configured for operation with DM-RS bundling, the UE can also be configured and/or indicated to transmit a second PUSCH in one or more of the L slots. It is possible that the first criterion to apply for prioritization of transmissions in slots where an overlap occurs is a value of a priority index associated to first and second transmissions, when provided and the transmission with the larger value of the priority index occurs while the other transmissions are dropped. When the priority index is not provided, or when the first and second transmissions have a same priority index, other criteria as in the following examples are considered.

In one example, the second PUSCH transmission is scheduled in a single slot i with 1≤i≤L.
In one sub-example, the first PUSCH transmission with repetitions or TB processing over multiple slots and with DM-RS bundling is prioritized subject to one or more of the following rules: (i) prioritization of a transmission with DM-RS bundling over a transmission without DM-RS bundling, (ii) prioritization of a transmission with DM-RS bundling over a transmission without repetitions, or (iii) prioritization of a transmission with DM-RS bundling over a transmission without repetitions in a specific slot i. The UE can postpone the deprioritized second PUSCH transmission until after the end of the first PUSCH transmission with repetitions, or can drop the second PUSCH transmission.
In another sub-example the second PUSCH transmission is prioritized over the first PUSCH transmission with DM-RS bundling. The prioritization is subject to one or more of the following rules: (i) the second PUSCH transmission has a higher priority than the first transmission, (ii) the second PUSCH transmission with no repetitions has priority over the first transmission with repetitions and DM-RS bundling, or (iii) the second transmission is scheduled in a specific slot i of the L slots of the DM-RS bundling, for example it is scheduled in the first slot i=1, in the last slot i=L, or in any of the slots with i≤L/2 or i≥L/2.
   The UE transmits the second PUSCH in slot i with a transmit power calculated based on a TPC command associated with the scheduled transmission, and/or on TPC commands received in a DCI format 2_2 with CRC scrambled by TPC-PUSCH-RNTI during a first time interval prior to the start of the first symbols of the second PUSCH transmission or the first symbol of slot i, and/or a closed loop power control (CLPC) accumulation state that accumulates TPC commands received over a second time interval. The second time interval may or may not include the portion of the time domain window for DM-RS bundling of the first transmission before slot i.
   The UE transmits the first PUSCH by applying DM-RS bundling over the L slots, or by applying DM-RS bundling in a first time window that includes slots before the slot i and in a second time window that includes slots after slot i, or by applying DM-RS bundling only before slot i. It is also possible that when i=1 the first PUSCH transmission with repetitions is postponed of 1 slot so that all scheduled repetitions are transmitted with DM-RS bundling.

In another example, the second PUSCH transmission is configured and/or scheduled with repetitions or TB processing over multiple slots and no DM-RS bundling.
In one sub-example the first PUSCH transmission with repetitions and DM-RS bundling is prioritized over the second transmission with repetitions. In slots where the first PUSCH transmission and the second PUSCH transmission overlap, the UE transmits the repetitions of the first PUSCH with DM-RS bundling and drops or postpones repetitions of the second PUSCH until after the end of the first PUSCH transmission with repetitions.
In another sub-example the first PUSCH transmission with repetitions and DM-RS bundling is prioritized over the second transmission with repetitions. In slots where the first PUSCH transmission and the second PUSCH transmission overlap, the UE transmits the repetitions of the first PUSCH without using DM-RS bundling. The UE applies DM-RS bundling for at least some repetitions of the first PUSCH that do not overlap with the second PUSCH such as the repetitions that are transmitted before the transmission of the second PUSCH.
In yet another sub-example in slots where the first PUSCH transmission, that is configured with DM-RS bundling, and the second PUSCH transmission, that is not configured with DM-RS bundling, overlap, the UE transmits the second PUSCH.

In another example, the second PUSCH transmission is configured and/or scheduled with repetitions or TB processing over multiple slots and is configured with DM-RS bundling.
In one sub-example, the first PUSCH transmission and the second PUSCH transmission have same priority index, and the first PUSCH transmission is prioritized respect to the second PUSCH transmission based on an earlier start time of the first PUSCH transmission. In the slots where the first PUSCH transmission and the second PUSCH transmission overlap, the UE transmits the repetitions of the first PUSCH with DM-RS bundling and drops, or postpones until after the end of the first PUSCH transmission, repetitions of the second PUSCH that overlap with repetitions of the first PUSCH transmission. The second PUSCH transmission is with DM-RS bundling.
In another sub-example, if the first PUSCH transmission and the second PUSCH transmission have same priority index and the first PUSCH transmission includes HARQ-ACK information or CSI, in slots where the first PUSCH transmission and the second PUSCH transmission overlap, the first PUSCH transmission is prioritized and repetitions of the second PUSCH transmission are dropped or postponed until after the first PUSCH transmission.
In yet another sub-example whether the first or the second PUSCH transmission is prioritized depends on a corresponding value of a priority index for the first PUSCH and for the second PUSCH. For example, if the second PUSCH transmission has a larger priority index, in slots where the first PUSCH transmission and the second PUSCH transmission overlap, the UE transmits the repetitions of the second PUSCH and drops, or postpones until after the end of the second PUSCH transmission, repetitions of the first PUSCH transmission. Whether to use DM-RS bundling over repetitions of the first PUSCH transmission after some of the repetitions are postponed or dropped can depend on whether the overlapped repetitions are postponed or dropped.

FIG. 9 illustrates an example method for determining a prioritization for simultaneous transmissions 900 according to embodiments of the disclosure. The embodiment of the example method for determining a prioritization for simultaneous transmissions 600 illustrated in FIG. 9 is for illustration only. FIG. 9 does not limit the scope of this disclosure to any particular implementation of the example method for determining a prioritization for simultaneous transmissions.

As illustrated in FIG. 9, at step 910, a UE (such as the UE 116) is configured for operation with DM-RS bundling, and is configured and/or indicated to transmit a number of PUSCHs that overlap in one or more slots. At step 920, the UE applies a first criterion to determine a prioritization of transmissions in slots where an overlap occurs based on values of a priority index associated to the PUSCH transmissions. At step 930, the UE applies a second criterion to determine the prioritization of transmissions in slots where the overlap occurs based on whether PUSCH transmissions are with DM-RS bundling. At step 940, the UE transmits a prioritized PUSCH in a slot where the overlap occurs and postpones or drops deprioritized PUSCHs.

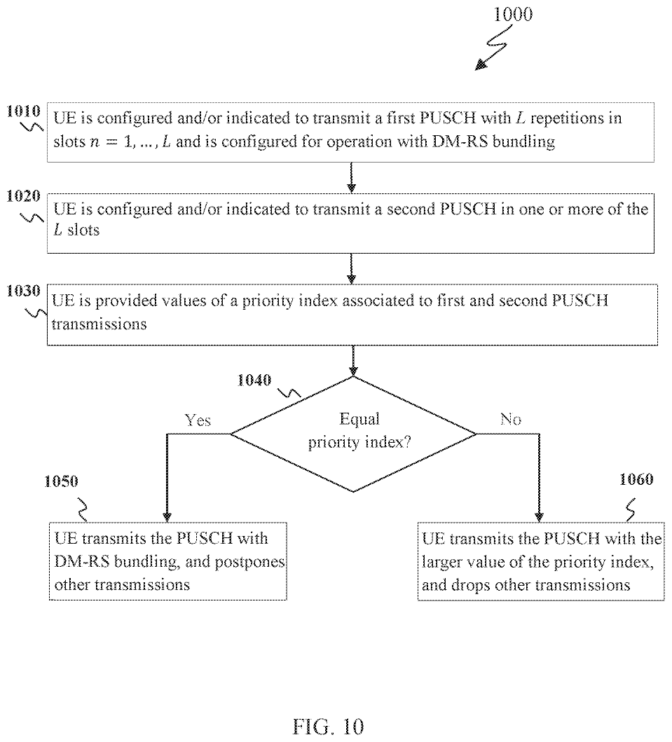

FIG. 10 illustrates an example method for determining a prioritization for simultaneous transmissions when one transmission is configured with DM-RS bundling 700 according to embodiments of the disclosure. The embodiment of the example method for determining a prioritization for simultaneous transmissions when one transmission is configured with DM-RS bundling 1000 illustrated in FIG. 10 is for illustration only. FIG. 10 does not limit the scope of this disclosure to any particular implementation of the example method for determining a prioritization for simultaneous transmissions when one transmission is configured with DM-RS bundling.

As illustrated in FIG. 10, at step 1010, a UE (such as the UE 116) is configured and/or indicated to transmit a first PUSCH with L repetitions in slots n=1, . . . , L and is configured for operation with DM-RS bundling. At step 1020, the UE is configured and/or indicated to transmit a second PUSCH in one or more of the L slots. At step 1030, the UE is provided values of a priority index associated to first and second PUSCH transmissions. At step 1040, when first and second transmissions have equal priority index, the UE transmits the PUSCH with DM-RS bundling and, postpones other transmissions at step 1050. Otherwise, at stepm1060, the UE transmits the PUSCH with the larger value of the priority index, and drops other transmissions.

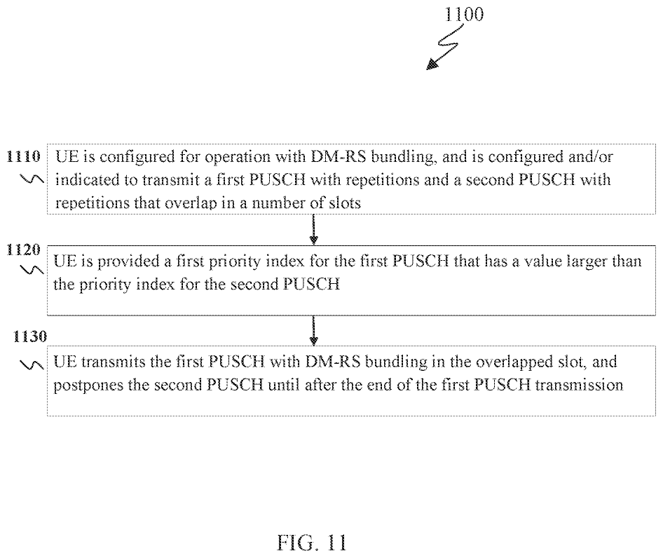

FIG. 11 illustrates an example method for determining a prioritization for simultaneous transmissions when first and second transmissions are with repetitions or TB processing over multiple slots and with DM-RS bundling 1100 according to embodiments of the disclosure. The embodiment of the example method for determining a prioritization for simultaneous transmissions when first and second transmissions are with repetitions or TB processing over multiple slots and with DM-RS bundling 1100 illustrated in FIG. 11 is for illustration only. FIG. 11 does not limit the scope of this disclosure to any particular implementation of the example method for determining a prioritization for simultaneous transmissions when first and second transmissions are with repetitions or TB processing over multiple slots and with DM-RS bundling.

As illustrated in FIG. 11, at step 1110, a UE (such as the UE 116) is configured for operation with DM-RS bundling and is configured and/or indicated to transmit a first PUSCH with repetitions and a second PUSCH with repetitions that overlap in a number of slots. At step 1120, the UE is provided a first priority index for the first PUSCH that has a value larger than the priority index for the second PUSCH. At step 1130, the UE transmits the first PUSCH with DM-RS bundling in the overlapped slot, and postpones the second PUSCH until after the end of the first PUSCH transmission.

The above descriptions for PUSCH transmissions also apply when the first channel is a PUCCH, or the second channel is a PUCCH, or both.

The above descriptions also apply when the UE is configured and/or indicated to transmit more than two PUSCHs that overlap in one or more slots. In the slots where an overlap occurs, the UE can determine the PUSCH transmission based on the priority index of the overlapping transmissions, and in case not provided or when all overlapping transmissions have the same priority, the UE can use other criteria as in the above examples and sub-examples. Deprioritized transmissions can be postponed or dropped. When there are multiple deprioritized transmissions, deprioritized transmissions can all be postponed or all be dropped, or some are postponed and some others are dropped.

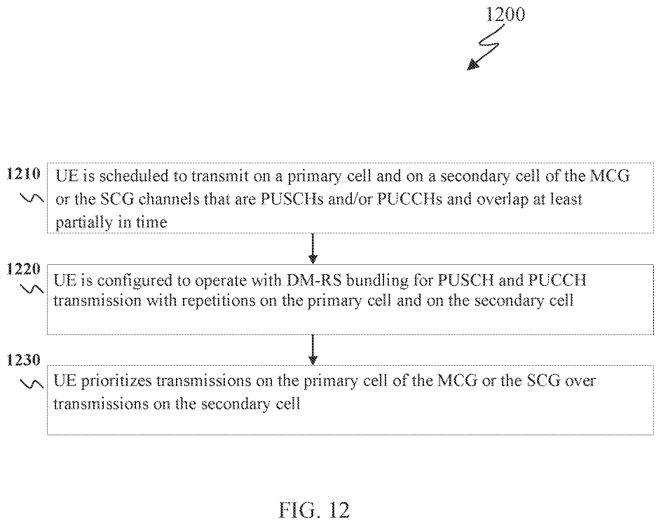

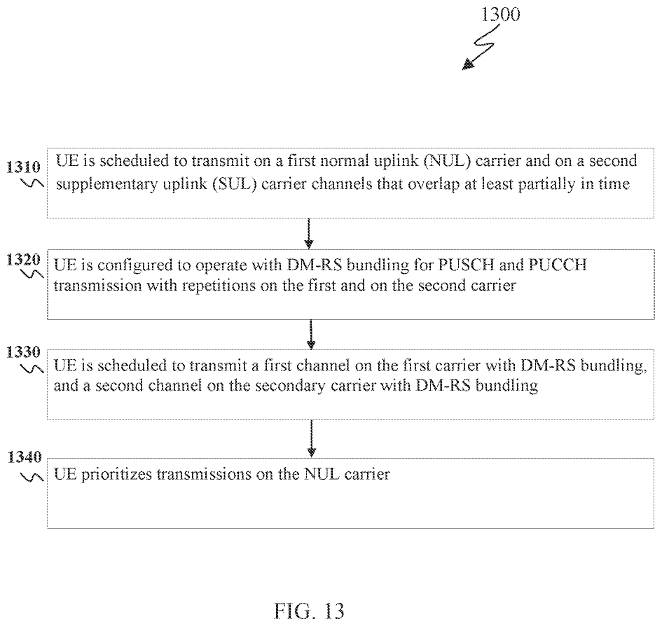

Embodiments of the present disclosure describe a determination of prioritizations of transmissions with DM-RS bundling for single cell operation with two uplink carriers or for operation with carrier aggregation. This is described in the following examples and embodiments, such as those of FIGS. 12-13.

In one example a UE is scheduled to transmit on a primary cell and a secondary cell, or on a normal uplink (NUL) carrier and supplementary uplink (SUL) carrier, and the scheduled transmissions are with repetitions, or are transmissions of TB processing over multiple slots, and overlap at least partially in time. The UE is configured to operate with DM-RS bundling for PUSCH and PUCCH transmission with repetitions.

For operation with carrier aggregation and for channels that are PUSCHs and/or PUCCHs, have same priority index, and have transmissions that overlap in time, when a UE
a) is scheduled to transmit a first channel with L repetitions on the primary cell of the MCG or the SCG, and
b) is configured for operation with DM-RS bundling over a first number of slots, and
c) is scheduled to transmit a second channel with M repetitions on the secondary cell of the MCG or the SCG, and
d) is configured for operation with DM-RS bundling over a second number of slots,
the UE prioritizes transmissions on the primary cell of the MCG or the SCG over transmissions on a secondary cell.

In case of channels with same value of a priority index having transmissions that overlap in time and for operation with two UL carriers, when a UE
a) is scheduled to transmit the first channel on the first carrier with DM-RS bundling, and
b) is scheduled to transmit the second channel on the secondary carrier with DM-RS bundling,
   the UE prioritizes transmissions on the carrier where the UE is configured to transmit PUCCH. If the UE does not transmit PUCCH on any of the two UL carriers, the UE prioritizes transmissions on the NUL carrier, or prioritizes transmissions on the carrier with the larger (or smaller) number of repetitions, or with the smaller (or larger) transmit power for the PUSCH transmission, or with the smaller (or larger) measured path loss that is used to calculate the transmit power. The UE can drop, or postpone until after the prioritized transmission, the deprioritized transmission on a cell or on a carrier.

In another example, a UE is scheduled to transmit on a primary cell and on a secondary cell, or on a NUL carrier and a SUL carrier, and on one cell or carrier the scheduled transmission is with repetitions or TB processing over multiple slots and with DM-RS bundling, and on the other cell or carrier the scheduled transmission is without repetitions.

For operation with carrier aggregation and for channels that are PUSCHs and/or PUCCHs, have same priority such as based on a value of a priority index, and overlap in time, when a UE
a) is scheduled to transmit a first channel with L repetitions on the primary cell of the MCG or the SCG, and
b) is configured for operation with DM-RS bundling over a first number of slots, and
c) is scheduled to transmit a second channel on the secondary cell of the MCG or the SCG in a slot that overlaps with the first channel transmission,
   the UE may prioritize a transmission based on one or a combination of the following rules:
i. prioritize transmissions on the primary cell of the MCG or the SCG over transmissions on a secondary cell (independently of whether or not the transmissions are configured with repetitions and/or with DM-RS bundling),
ii. prioritize transmissions configured with DM-RS bundling over transmissions without DM-RS bundling configuration,
iii. prioritize transmissions with repetitions over transmissions with no repetition.

In case of same priority index and for operation with two UL carriers where PUSCH transmissions on the two UL carriers would overlap in time, when the UE
a) is scheduled to transmit the first PUSCH on the first carrier with DM-RS bundling, and
b) is scheduled to transmit the second PUSCH on the second carrier, the UE may prioritize the first or second PUSCH transmission based on one or a combination of the following rules:
i. prioritize transmissions on the carrier where the UE is configured to transmit PUCCH and, if PUCCH is not configured for any of the two UL carriers, prioritize transmissions on the NUL carrier;
ii. prioritize transmissions on the carrier where the UE is configured to transmit PUCCH and, if PUCCH is not configured for any of the two UL carriers, prioritize transmissions on the UL carrier with PUSCH transmissions configured with DM-RS bundling;
iii. prioritize transmissions on the carrier where the UE is configured to transmit PUCCH and, if PUCCH is not configured for any of the two UL carriers, prioritize transmission on the UL carrier with PUSCH transmission with no repetitions.

In (ii), the UE can drop, or postpone and transmit after completion of the prioritized transmission with DM-RS bundling on the first carrier, a deprioritized PUSCH transmission with no repetitions on the second carrier.

In (iii), the UE can drop, or postpone and transmit after completion of the prioritized transmission with DM-RS bundling on the second carrier, a deprioritized PUSCH transmission with repetitions and DM-RS bundling on the first carrier. On the first carrier, the UE can apply DM-RS bundling to repetitions of the first PUSCH before the slot where the second PUSCH transmission is prioritized (time window-1) and to repetitions of the first PUSCH after the slot where the second PUSCH transmission is prioritized (time window-2). The transmit power during the time window-1 and time window-2 is not required to be same. PUSCH transmissions on the first carrier, after the slot where the second PUSCH transmission is prioritized, can also be transmitted without DM-RS bundling and the transmit power of each PUSCH transmission can be updated.

In a third example a UE is scheduled to transmit on a primary cell and a secondary cell, or on a normal uplink (NUL) carrier and supplementary uplink (SUL) carrier, and the scheduled transmissions are with repetitions, or are transmissions of TB processing over multiple slots, and overlap at least partially in time. The UE is configured to operate with DM-RS bundling for PUSCH and PUCCH transmission with repetitions or for transmissions of TB processing over multiple slots on the primary cell and is not configured to operate with DM-RS bundling on the secondary cell.

For operation with carrier aggregation and for channels that are PUSCHs and/or PUCCHs, have same priority index, and have transmissions that overlap in time, when a UE
a) is scheduled to transmit a first channel with L repetitions on the primary cell of the MCG or the SCG, and
b) is configured for operation with DM-RS bundling over a first number of slots, and
c) is scheduled to transmit a second channel with M repetitions on the secondary cell of the MCG or the SCG, and
d) is not configured for operation with DM-RS bundling,
the UE prioritizes transmissions on the primary cell of the MCG or the SCG over transmissions on a secondary cell.

In case of channels with same value of a priority index having transmissions that overlap in time and for operation with two UL carriers, when a UE
a) is scheduled to transmit the first channel on the first carrier with DM-RS bundling, and
b) is scheduled to transmit the second channel on the secondary carrier without DM-RS bundling,
   the UE prioritizes transmissions on the carrier where the UE is configured to transmit PUCCH. If the UE does not transmit PUCCH on any of the two UL carriers, the UE prioritizes transmissions on the NUL carrier independently of whether or not the transmissions on the NUL carrier are with DM-RS bundling, or prioritizes transmissions on the carrier configured with DM-RS bundling independently of whether or not the transmissions are on the NUL. The UE can drop, or postpone until after the prioritized transmission, the deprioritized transmission on a cell or on a carrier.

In another example a UE is scheduled to transmit on a primary cell and on multiple secondary cells, or on multiple normal uplink (NUL) carriers and a supplementary uplink (SUL) carrier, and the scheduled transmissions are with repetitions, or are transmissions of TB processing over multiple slots, and overlap at least partially in time. The UE is configured to operate with DM-RS bundling for PUSCH and PUCCH transmission with repetitions or for transmissions of TB processing over multiple slots on the primary and secondary cells, or on the NUL carriers and on the SUL carrier.

For operation with carrier aggregation and for channels that are PUSCHs and/or PUCCHs, have same priority index, and have transmissions that overlap in time, when a UE
a) is scheduled to transmit a first channel with L repetitions on the primary cell of the MCG or the SCG, and
b) is configured for operation with DM-RS bundling over a first number of slots, and
c) is scheduled to transmit other channels with repetitions on the number of secondary cells of the MCG or the SCG, and
d) is configured for operation with DM-RS bundling,
the UE prioritizes transmissions on the primary cell of the MCG or the SCG over transmissions on any of the secondary cells.

In case of channels with same value of a priority index having transmissions that overlap in time and for operation with multiple UL carriers, when a UE
a) is scheduled to transmit the first channel on the first carrier with DM-RS bundling, and
b) is scheduled to transmit other channels on the multiple carriers with DM-RS bundling,
   the UE prioritizes transmissions on the carrier where the UE is configured to transmit PUCCH. If the UE does not transmit PUCCH on any of the UL carriers, the UE prioritizes transmissions on NUL carriers over the SUL carrier. Among the NUL carriers, when all overlapping transmissions are with DM-RS bundling, the UE prioritizes transmissions on the carrier with the larger (or smaller) number of repetitions, or with the smaller (or larger) transmit power for the PUSCH transmission, or with the smaller (or larger) measured path loss that is used to calculate the transmit power. The UE can drop, or postpone until after the prioritized transmission, the deprioritized transmissions on other cells or on other carriers. It is also possible that the UE postpones one deprioritized transmission and drops other deprioritized transmissions. The deprioritized transmission that is postponed is selected based on the carrier with the larger (or smaller) number of repetitions, or with the smaller (or larger) transmit power for the PUSCH transmission, or with the smaller (or larger) measured path loss that is used to calculate the transmit power.

In another example a UE is scheduled to transmit on a primary cell and on multiple secondary cells, or on multiple normal uplink (NUL) carriers and a supplementary uplink (SUL) carrier, and the scheduled transmissions are with repetitions, or are transmissions of TB processing over multiple slots, and overlap at least partially in time. The UE is configured to operate with DM-RS bundling for PUSCH and PUCCH transmission with repetitions or for transmissions of TB processing over multiple slots on at least one among the primary and secondary cells, or on at least one of the NUL carriers and SUL carrier.

For operation with carrier aggregation and for channels that are PUSCHs and/or PUCCHs, have same priority index, and have transmissions that overlap in time, when a UE
a) is scheduled to transmit a first channel with L repetitions on the primary cell of the MCG or the SCG, and
b) may or may not be configured for operation with DM-RS bundling over a first number of slots, and
c) is scheduled to transmit other channels with repetitions on the number of secondary cells of the MCG or the SCG, and
d) may or may not be configured for operation with DM-RS bundling,
the UE prioritizes transmissions on the primary cell of the MCG or the SCG over transmissions on any of the secondary cells independently of whether or not the transmissions are configured with DM-RS bundling.

In case of channels with same value of a priority index having transmissions that overlap in time and for operation with multiple UL carriers, when a UE
a) is scheduled to transmit the first channel on the first carrier with DM-RS bundling, and
b) is scheduled to transmit other channels on the multiple carriers with DM-RS bundling, the UE prioritizes transmissions on the carrier where the UE is configured to transmit PUCCH. If the UE does not transmit PUCCH on any of the UL carriers, the UE prioritizes transmissions on either an NUL or SUL carrier that is configured with DM-RS bundling. Among NUL and SUL carriers, when more than one overlapping transmission is with DM-RS bundling, the UE prioritizes transmissions on the carrier with the larger (or smaller) number of repetitions, or with the smaller (or larger) transmit power for the PUSCH transmission, or with the smaller (or larger) measured path loss that is used to calculate the transmit power.

In case of channels with same value of a priority index having transmissions that overlap in time and for operation with multiple UL carriers, when a UE
a) is scheduled to transmit the first channel on the first carrier with DM-RS bundling, and
b) is scheduled to transmit other channels on the multiple carriers without DM-RS bundling, the UE prioritizes transmissions on the carrier where the UE is configured to transmit PUCCH. If the UE does not transmit PUCCH on any of the UL carriers, the UE prioritizes transmissions based on whether a carrier is an NUL or an SUL carrier and/or on whether the carrier is configured or not with DM-RS bundling. (i) The UE prioritizes transmissions on NUL carriers over the SUL carrier if at least one of the overlapping transmissions over NUL carrier is configured with DM-RS bundling. (ii) The UE prioritizes transmissions on the SUL carrier over the NUL carriers if the SUL carrier is configured with DM-RS bundling and none of the NUL carriers is configured with DM-RS bundling. (iii) The UE prioritizes transmissions on a carrier that is configured with DM-RS bundling independently on whether the carrier is an NUL or SUL carrier.

It is also possible that a UE is configured to transmit on multiple supplementary uplink (SUL) carriers. In case of channels with same value of a priority index having transmissions that overlap in time and for operation with multiple UL carriers, when a UE
a) is scheduled to transmit the first channel on the first carrier with DM-RS bundling, and
b) is scheduled to transmit other channels on the multiple carriers with DM-RS bundling, the UE prioritizes transmissions on the carrier where the UE is configured to transmit PUCCH. If the UE does not transmit PUCCH on any of the UL carriers, the UE prioritizes transmissions based on whether a carrier is an NUL or an SUL carrier and/or on whether the carrier is configured or not with DM-RS bundling.

FIG. 12 illustrates an example method 1200 for determining a prioritization for simultaneous transmissions over multiple cells according to embodiments of the disclosure. The embodiment of the example method 1200 for determining a prioritization for simultaneous transmissions over multiple cells illustrated in FIG. 12 is for illustration only. FIG. 12 does not limit the scope of this disclosure to any particular implementation of the example method for determining a prioritization for simultaneous transmissions over multiple cells.

As illustrated in FIG. 12, at step 1210, a UE (such as the UE 116) is scheduled to transmit on a primary cell and on a secondary cell of the MCG or the SCG channels that are PUSCHs and/or PUCCHs and overlap at least partially in time. At step 1220, the UE is configured to operate with DM-RS bundling for PUSCH and PUCCH transmission with repetitions on the primary cell and on the secondary cell. At step 1230, the UE prioritizes transmissions on the primary cell of the MCG or the SCG over transmissions on a secondary cell.

FIG. 13 illustrates an example method 1300 for determining a prioritization for simultaneous transmissions over multiple uplink carriers according to embodiments of the disclosure. The embodiment of the example method 1300 for determining a prioritization for simultaneous transmissions over multiple uplink carriers illustrated in FIG. 13 is for illustration only. FIG. 13 does not limit the scope of this disclosure to any particular implementation of the example method for determining a prioritization for simultaneous transmissions over multiple uplink carriers.

As illustrated in FIG. 13, at step 1310, a UE (such as the UE 116) is scheduled to transmit on a first normal uplink (NUL) carrier and on a second supplementary uplink (SUL) carrier channels that overlap at least partially in time. At step 1320, the UE is configured to operate with DM-RS bundling for PUSCH and PUCCH transmission with repetitions on the first and on the second carrier. At step 1330, the UE is scheduled to transmit a first channel on the first carrier with DM-RS bundling, and a second channel on the secondary carrier with DM-RS bundling. At step 1340, the UE prioritizes transmissions on the NUL carrier.

When a UE is configured and/or indicated to transmit a first PUSCH with L repetitions in slots n=1, . . . , L with DM-RS bundling over a first time window of L slots, and is configured and/or indicated to transmit a second PUSCH with M repetitions in slots n=L+1, . . . , L+M with DM-RS bundling over a second time window of M slots, the transmit power during the first time window can be same or different than the transmit power during the second time window. For example, when the UE can maintain phase continuity over the transmission in slot L and the transmission in slot L+1, the UE can transmit the second PUSCH repetitions in the second time window with same power as the power of the PUSCH repetitions in the first time window. This allows a gNB to filter DM-RS over the L+M slots of the first and second time windows for estimating the channel to demodulate the modulated data information symbols in the PUSCH repetitions over the first and second time windows.

It is also possible that the UE updates the transmit power of the second time window, and that the value of the transmit power during the second time window is derived based on the transmit power during the first time window and a factor δ. For example, P₂=P₁+δ (in dB), wherein P₁ is the transmit power in the first time window, P₂ is the transmit power in the second time window and δ can have a positive or negative or zero value. When, in addition to maintaining phase continuity among transmissions in each of the time windows, the UE can maintain phase continuity, or the variation in phase is within a number of degrees, between the transmission in slot L and the transmission in slot L+1, the gNB can filter DM-RS over the L+M slots of the first and second time windows to estimate the channel after applying the scaling factor δ. Such scaling factor needs to be signaled by the UE to the gNB, or can be a configured value by the gNB and the UE indicates whether there is an increase or a decrease of the transmit power in the second time window relative the first time window.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information for:
synchronization signals and physical broadcast channel (SS/PBCH) blocks over a first set of symbols of a slot, wherein the SS/PBCH blocks are associated with physical cell identities (PCIs) that are different than a PCI of a serving cell of the UE, and
parameters for transmission of a physical uplink shared channel (PUSCH); and
a processor operably coupled to the transceiver, the processor configured to:
identify, according to the parameters, a second set of symbols in the slot for transmission of the PUSCH, and
determine an availability of the slot for the transmission of the PUSCH when the second set of symbols does not include any symbol from the first set of symbols.

2. The UE of claim 1, wherein the first set of symbols in the slot does not include all symbols of a SS/PBCH block associated with the PCI of the serving cell.

3. The UE of claim 1, wherein:
the transceiver is further configured to receive the SS/PBCH blocks; and
the processor is further configured to determine:
a first SS/PBCH block, from the SS/PBCH blocks, with a smallest path loss,
a third set of symbols for the first SS/PBCH block, and
the availability of the slot for the transmission of the PUSCH when:
the second set of symbols does not include any symbol from the third set of symbols, and
the second set of symbols includes a symbol from the first set of symbols.

4. The UE of claim 1, wherein:
the processor is further configured to determine the availability of the slot for the transmission of the PUSCH when:
the second set of symbols includes a symbol from the first set of symbols, and
frequency resources for the SS/PBCH blocks do not include frequency resources for the PUSCH.

5. The UE of claim 1, wherein:
a SS/PBCH block associated with the PCI of the serving cell is associated with a first transmission configuration indication (TCI) state,
the SS/PBCH blocks are associated with second TCI states, and
the first TCI state is different than any TCI state from the second TCI states.

6. The UE of claim 1, wherein:
the transceiver is further configured to receive information for:
a number of repetitions for the transmission of the PUSCH, and
a counter for the number of repetitions that corresponds to one of:
a number of consecutive slots, or
a number of transmitted repetitions;
the processor is further configured to determine:
a value of the counter for the number of repetitions, and
an indication for transmitting a repetition for the transmission of the PUSCH in the slot based on:
the availability, and
the value of the counter for the number of repetitions; and
the transceiver is further configured to transmit the repetition for the transmission of the PUSCH in the slot based on the indication.

7. The UE of claim 6, wherein:
counting the number of repetitions is according to transmitted repetitions,
the value of the counter for the number of repetitions is less than the number of repetitions,
the slot is not available for transmitting the repetition for the transmission of the PUSCH, and
the transceiver is further configured to postpone transmitting the repetition for the transmission of the PUSCH to a next slot.

8. A base station (BS) comprising:
a transceiver configured to transmit information for:
synchronization signals and physical broadcast channel (SS/PBCH) blocks over a first set of symbols of a slot, wherein the SS/PBCH blocks are associated with physical cell identities (PCIs) that are different than a PCI of a serving cell, and
parameters for reception of a physical uplink shared channel (PUSCH); and
a processor operably coupled to the transceiver, the processor configured to:
identify, according to the parameters, a second set of symbols in the slot for reception of the PUSCH, and
determine an availability of the slot for the reception of the PUSCH when the second set of symbols does not include any symbol from the first set of symbols.

9. The BS of claim 8, wherein the first set of symbols in the slot does not include all symbols of a SS/PBCH block associated with the PCI of the serving cell.

10. The BS of claim 8, wherein:
the transceiver is further configured to transmit the SS/PBCH blocks; and
the processor is further configured to determine:
a first SS/PBCH block, from the SS/PBCH blocks, with a smallest path loss,
a third set of symbols for the first SS/PBCH block, and
the availability of the slot for the reception of the PUSCH when:
the second set of symbols does not include any symbol from the third set of symbols, and
the second set of symbols includes a symbol from the first set of symbols.

11. The BS of claim 8, wherein:
the processor is further configured to determine the availability of the slot for the reception of the PUSCH when:
the second set of symbols includes a symbol from the first set of symbols, and
frequency resources for the SS/PBCH blocks do not include frequency resources for the PUSCH.

12. The BS of claim 8, wherein:
a SS/PBCH block associated with the PCI of the serving cell is associated with a first reception configuration indication (TCI) state,
the SS/PBCH blocks are associated with second TCI states, and
the first TCI state is different than any TCI state from the second TCI states.

13. The BS of claim 8, wherein:
the transceiver is further configured to transmit information for:
a number of repetitions for the reception of the PUSCH, and
a counter for the number of repetitions that corresponds to one of:
a number of consecutive slots, or
a number of received repetitions;
the processor is further configured to determine:
a value of the counter for the number of repetitions, and
an indication for receiving a repetition for the reception of the PUSCH in the slot based on:
the availability, and
the value of the counter for the number of repetitions; and
the transceiver is further configured to receive the repetition for the reception of the PUSCH in the slot based on the indication.

14. A method for operating a user equipment (UE), the method comprising:
receiving information for:
synchronization signals and physical broadcast channel (SS/PBCH) blocks over a first set of symbols of a slot, wherein the SS/PBCH blocks are associated with physical cell identities (PCIs) that are different than a PCI of a serving cell of the UE, and
parameters for transmission of a physical uplink shared channel (PUSCH);
identifying, according to the parameters, a second set of symbols in the slot for transmission of the PUSCH; and
determining an availability of the slot for the transmission of the PUSCH when the second set of symbols does not include any symbol from the first set of symbols.

15. The method of claim 14, wherein the first set of symbols in the slot does not include all symbols of a SS/PBCH block associated with the PCI of the serving cell.

16. The method of claim 14, further comprising:
receiving the SS/PBCH blocks; and
determining:
a first SS/PBCH block, from the SS/PBCH blocks, with a smallest path loss,
a third set of symbols for the first SS/PBCH block, and
the availability of the slot for the transmission of the PUSCH when:
the second set of symbols does not include any symbol from the third set of symbols, and
the second set of symbols includes a symbol from the first set of symbols.

17. The method of claim 14, further comprising:
determining the availability of the slot for the transmission of the PUSCH when:
the second set of symbols includes a symbol from the first set of symbols, and
frequency resources for the SS/PBCH blocks do not include frequency resources for the PUSCH.

18. The method of claim 14, wherein:
a SS/PBCH block associated with the PCI of the serving cell is associated with a first transmission configuration indication (TCI) state,
the SS/PBCH blocks are associated with second TCI states, and
the first TCI state is different than any TCI state from the second TCI states.

19. The method of claim 14, further comprising:
receiving information for:
a number of repetitions for the transmission of the PUSCH, and
a counter for the number of repetitions that corresponds to one of:
a number of consecutive slots, or
a number of transmitted repetitions;
determining:
a value of the counter for the number of repetitions, and
an indication for transmitting a repetition for the transmission of the PUSCH in the slot based on:
the availability, and
the value of the counter for the number of repetitions; and
transmitting the repetition for the transmission of the PUSCH in the slot based on the indication.

20. The method of claim 19, wherein:
counting the number of repetitions is according to transmitted repetitions,
the value of the counter for the number of repetitions is less than the number of repetitions,
the slot is not available for transmitting the repetition for the transmission of the PUSCH, and
the method further comprises postponing transmitting the repetition for the transmission of the PUSCH to a next slot.
